(19) United States
(12) Patent Application Publication
(10) Pub. No.: US 2026/0033511 A1
(43) Pub. Date: Feb. 5, 2026

(54) COMPRESSED FORMED FOOD PRODUCTS AND METHODS OF MAKING

(71) Applicants: Brett David SCHUMACHER, Minneapolis, MN (US); WHIRL'D PROVISIONS, INC., Minneapolis, MN (US)

(72) Inventor: Brett David SCHUMACHER, Minneapolis, MN (US)

(21) Appl. No.: 19/099,876

(22) PCT Filed: Aug. 1, 2023
(86) PCT No.: PCT/US2023/071429

§ 371 Date: Jan. 30, 2025

Related U.S. Application Data
(60) Provisional application No. 63/395,005, filed on Aug. 4, 2022.

(51) Int. Cl. A23C 11/10; A23L 7/17; A23L 9/20; A23P 30/10; A23P 30/20

(52) U.S. Cl. CPC A23C 11/10; A23L 7/17; A23L 9/24; A23P 30/10; A23P 30/20

(57) ABSTRACT

A solid oat milk alternative product is formed by mixing a dry base that includes about 60% to about 80% by weight of whole oat flour; about 0% to about 5% by weight of an emulsifier, about 0.1% to about 5% by weight of a stabilizer, about 0% to about 1% by weight of a foaming enhancer. The dry base is mixed with about 15% to about 30% by weight of an oil to form a dough. The dough is compressed or extruded to form the solid oat milk product.

### FIELD OF THE INVENTION

The general field of the present disclosure are novel compressed food products and methods of making same. The product field is plant-based oat milk alternatives, plant-based oat cream, and/or plant-based cream alternatives, including plant-based milk alternative blends including barista editions and flavors.

### BACKGROUND OF THE INVENTION

Dehydration, such as freeze-drying or vacuum oven drying, is commonly used to preserve and prepare plant-based material, such as fruits and vegetables, as well as meats, for use in food products. Such products are then compressed, a process that involves reducing the size or volume of the food product. Coupled together, dehydration and compression of foods allow for the preservation of fresh food commodities to increase longevity; a reduction in the weight and volume of the food product for easier transport and storage; promotion of sustainability as these techniques utilize large quantities of energy at low efficiency; and preservation of the nutrition and quality of the food (Calín-Sánchez et al, “Comparison of Traditional and Novel Drying Techniques and Its Effect on Quality of Fruits, Vegetables and Aromatic Herbs,” 2020 Sep. 9;9(9):1261). Due to these various advantages, military and commercial endeavors are aimed at optimizing dehydration and compression techniques to ensure these methods are as cost-effective as possible, while still generating high quality food products. Researchers have specifically detailed the direct compression method, by which a food item or ingredient is taken as it is or with another ingredient and compressed, as being a low-cost and time-saving option (Abu Fara et al, “Understanding the Performance of a Novel Direct Compression Excipient Comprising Roller Compacted Chitin,” Mar Drugs. 2020 Feb. 17;18(2):115).

U.S. Pat. No. 11,350,658 discloses the use of this method to produce allulose (a sugar sweetener) granules. Many direct compression procedures require the use of other ingredients such as diluents to aid with compression; disintegrates to facilitate disintegration of tablet or final compressed product into an aqueous media; lubricants to help form the structure of the product; glidants to aid the machine during compression; and pH stabilizing agents, colorants, flavors or surfactants to form the final desired product. However, the use of these agents allows for little amount of other food material to be present in the resulting tablet or granule. U.S. Pat. No. 11,350,658 disclosed a way to generate allulose granules through the use of compressing a granulation liquid consisting of allulose and water, with an allulose powder. The nature of allulose allows binding between the liquid and powder, thus resulting in an allulose granule with a set thickness, density and hardness.

WO2004112513A1 disclosed a method to produce bouillon cubes. The inventors describe mixing a combination of a fat-based granule or water-based granule (mixture of bouillon, broth, soup, sauce or seasoning with a fat or oil, or water) with another fat-based or water-based granule, or a fat-based or water-based powder mix (similar mixture as granules except with a fat powder, small amount of water, or no water with water being added later). These two factions would then be mixed and compressed through common techniques known in the art. The factions would also purposely be made into different colors, so after compression, the resulting granule or cube would clearly contain two different matrices.

While there have been many advancements in this field, complications still arise around preservation of wholly liquid food items, such as cow's milk. Traditional dehydration and compression techniques described above are not applicable to typical milk products and, because it spoils very quickly, preservation of cow's milk is very difficult. Milk poses additional problems as it one of the most common allergies among children and lactose intolerance hinders many from consumption. This has largely lead to an increase in the popularity of non-dairy alternatives or plant-based milks, which include, but are not limited to, milks such as soy milk, almond milk, rice milk, cashew milk coconut milk and oat milk. Commercial producers have also successfully introduced several milk blends in the United States and other countries. See for example Vanga et al., “How well do plant based alternatives fare nutritionally compared to cow's milk?,” (2018) J Food Sci Technol. 55(1): pp. 10-20. There are several processes in which to prepare plant-based milks, with the two most common methods being wet processing and dry processing.

### Wet Processing of Ingredients

It is known that wet processing, which involves soaking and grinding. For example, cereals, legumes, nuts, or seeds being placed in large stainless steel kettles containing filtered water and a small amount of salt. Soaking times vary based on the plant hydration rate but can take up to 12 hours. Soaking is used to remove enzyme inhibitors, affect digestibility and bioavailability. After soaking, the cereals, legumes, nuts, or seeds are rinsed and drained. Next, they are ground into a smooth puree or paste. Hammer mills are commonly used at this stage in processing. See McHugh, “How Plant-Based Milks Are Processed,” (2018) 72:(12). In addition, enzymes may be added to hydrolyze starches in for example, for oat milk. Other steps may include a blanching step may be employed with or without the addition of sodium bicarbonate, as is performed for soy milks. Although some nuts, like macadamias, cashews, and pecans, grind easily, yielding smooth purees or pastes, other nuts and plant materials, like almonds, retain undesirable textures after grinding due to their skins or other fibrous components. These undesirable components can be centrifuged or filtered out of the milks to obtain smooth final textures. Alternately, fine grinding processes resulting in very small particle sizes can be used to obtain desired final consistencies. Heating and homogenization are often performed at this stage to inactivate enzymes and improve stability of the final beverage. Id.

### Dry Processing

An alternative process is the dry process which can typically involve harvesting the materials such as plants, legumes or peanuts, for example, drying them (with or without blanching), and milling them into flours. Hammer, pin, or other types of mills may be used. The flour can then be processed to separate the protein from the starch and fiber as desired. Then the protein concentrate, or isolate can be used in the next step to formulate the beverage. The dry process is sometimes superior to wet processing in that higher protein contents in the end products. See McHugh, 2018.

The final step to prepare plant-based milk, as well as any milk product, is to sterilize the product. Liquids can be processed via ultra-high temperature technology and methodologies to create a sterile product/liquid that can be inserted into an aseptic package, which is also sterile, and then undergoes an additional heat step to sterilize the entire packed product, with hermetic scaling to guarantee long shelf life and food safety. See for example McHugh, 2018.

Similarly, dairy products must be pasteurized. Originally, pasteurization was vat pasteurization, which heats milk or other liquid ingredients in a large tank for at least 30 minutes. It is now used primarily in the dairy industry for preparing milk for making starter cultures in the processing of cheese, yogurt, and buttermilk and for pasteurizing some ice cream mixes.

A common method of pasteurization known in the art as used in the United States today is high temperature short time (HTST) pasteurization, which uses metal plates and hot water to raise milk temperatures to at least 161° F. for not less than 15 seconds, followed by rapid cooling. Higher Heat Shorter Time (HHST) is a process similar to HTST pasteurization, but it uses slightly different equipment and higher temperatures for a shorter time. For a product to be considered ultra pasteurized (UP), it must be heated to not less than 280° F. for two seconds. UP pasteurization results in a product with longer shelf life but still requiring refrigeration. Another method, aseptic processing, which is also known as ultra high temperature (UHT), involves heating the milk using commercially sterile equipment and filling it under aseptic conditions into hermetically sealed packaging. The product is termed “shelf stable” and does not need refrigeration until opened. Such aseptic processing must be approved with the FDA. See for example International Dairy Foods Association, “Pasteurization” published at: https://www.idfa.org/pasteurization.

While these thermal pasteurization practices are very common and useful, it is important to note that traditional pasteurization does not guarantee the safety or longevity of the product, as pasteurized foods can still become contaminated through preparation, storage and food handling practices (www.healthline.com/nutrition/pasteurized-vs-unpasteurized#pasteurized). Additionally, pasteurization can impact the quality of the food product. The use of high temperatures in these processes may undesirably modify the physical, chemical, sensory and nutritional characteristics of food and beverages. See Bocker et al., “Innovative technologies for manufacturing plant-based non-dairy alternative milk and their impact on nutritional, sensory and safety aspects,” (2022) Future Foods 5:100098. In terms of milk production, these side effects of pasteurization, specifically its impact on nutrition, become very impactful as milk is one of the most highly consumed products in the world. Previous work has identified that natural cow's milk is highly nutritious, but pasteurization can negatively affect vitamins, with vitamins B12 and E displaying a quantitative decrease post pasteurization. See Macdonald et al, “A systematic review and meta-analysis of the effects of pasteurization on milk vitamins, and evidence for raw milk consumption and other health-related outcomes,” (2011) J Food Prot. 2011 74(11): pp. 1814-1832).

These disadvantages of pasteurization have largely contributed to the development of emerging technologies aimed at treating dairy and non-dairy alternatives, with a goal of ridding the food products of dangerous microorganisms without causing excessive changes to the quality and characteristics of the food item. Europe, for example, has adopted the ultra-violet (UV) radiation methods of treating dairy products such as milk. See for example, “Safety of UV-treated milk as a novel food pursuant to Regulation (EC) No 258/97: EFSA Panel on Dietetic Products, Nutrition and Allergies (NDA),” (2016) Eur. Food Safety Authority Journal 14(1): 4370. Under this process, the food product is treated with UV radiation at a set dose and temperature, for a certain period of time, which can destroy or inactivate certain microorganisms. Other technologies, such as high-intensity ultrasound, high-pressure processing, pulsed electric field and ohmic heating among others, have been effective in stabilizing dairy and non-dairy products. These techniques can reduce microbiological and enzymatic activity which can prolong shelf-life and influence safety of the food products. However, there may be large economic costs associated with these new techniques as they can require expensive machinery and still need more research to fully understand their scope and effectiveness. Additionally, there is still the issue of excessively altering the food item itself. UV radiation has been shown to discolor or alter the physical attributes of dairy products, as well as alter the chemical characteristics, such as fatty acid profile. See Delorme et al., “Ultraviolet radiation: An interesting technology to preserve quality and safety of milk and dairy foods,” (2020) Trends In Food Science & Technology 102: pp. 146-154. Similarly, ultrasound technologies have also been demonstrated to alter the textures of milk and dairy products, and negatively impact levels of vitamins. See Carillo-Lopez et al., “Recent advances in the application of ultrasound in dairy products: Effect on functional, physical, chemical, microbiological and sensory properties,” (2021) Ultrasonics Sonochemistry 73: p. 105467.

Issues concerning processing of dairy and non-dairy products become more prevalent when manufacturing plant-based milks, such as oat milk. Oat milk naturally does not have many of the vitamins and nutrients found in cow's milk and has a dissimilar texture. This leads to additional processing as these milks must be fortified with other vitamins and minerals or treated with other chemicals to allow emulsion and generation of a consumable and desirable liquid product. See Sethi et al., “Plant-based milk alternatives an emerging segment of functional beverages: a review,” (2016) J Food Sci Technol. 53(9): pp. 3408-3423. Notably, this amount of processing can alter the nutritional and chemical content of oat milk, especially since oat milk must still be heated or pasteurized prior to consumption.

Prior art has described new techniques for oat milk production. US20130017300 discloses a method to produce a milk-based oat beverage consisting of hydrolyzed oat flour, a fluid milk, sweetener, stabilizer and a salt, mixed under chilled conditions. The use of hydrolyzed flour eliminates the need to fully hydrate or heat the oat flour, creating a more cost and energy efficient method; as well as allow the produce a 6-month shelf-life. However, the final product still needs to be UHT pasteurized and refrigerated. WO2014123466 discloses another method in which to produce oat milk in a way to increase protein content. This is done by preparing a liquid oat base made from oat material solubilized in a solvent containing water and glutaminase, a protein-deamidase. This enzyme allows for increased solubility of oat protein and improves texture and taste. However, later work has shown that glutaminase may have low enzymatic performance and yield in a large-scale setting. See Liu et al., “Application Prospect of Protein-Glutaminase in the Development of Plant-Based Protein Foods,” (2022) Food 11(3): p. 440.

Altogether, a new method of oat milk production is needed, that bypasses the many pitfalls and struggles of current techniques. The current application addresses these needs.

### SUMMARY OF THE INVENTION

The invention is described in more detail on the attached methods and formula and recipes and accompanying claims.

The current invention provides novel compressed or extruded food products and methods of making same. Novel compressed food products include plant-based oat milk alternatives, including plant-based milk alternative blends including barista editions and flavors. Described herein is a solid oat milk product prepared with a dry mixed oat milk base that is blended with an oil and then compressed under pressure. When the product is prepared for use by adding water, the product creates a highly functional liquid oat milk beverage for use by coffee baristas and at home consumers. In examples, the disclosed product may be prepared for use by adding to water to be reconstituted as a liquid oat milk beverage to add to coffee or tea beverages as alternatives to dairy-based beverage additives such as milk or cream, or non-dairy coffee creamers or whiteners. The disclosed product functions similar or better than currently available oat milk beverages regarding foaming, flavor, mouthfeel, and stability.

The novel solid oat milk product and process described herein for preparing the product yield key benefits in providing an oat milk product for use in beverages made by coffee shops, baristas, and consumers. The product and process offer environmentally sustainable and low-waste availability of an oat milk product with good foaming, flavor, and stability features. The product and process offer lower-energy production methods as contrasted with those that rely on dehydration, which has a high energy input requirement. The product and process offer great improvement in reduction of packaging, in the nature of about a +90 percent reduction in product packaging for the solid oat milk product described herein, compared to packaging required for oat milks sold in liquid form. The solid oat milk product and process for preparing the product as described herein yield great improvements in sustainable commercial production, distribution, and use, and reduction of product waste, in view of the longer shelf life and higher stability of the solid oat milk product produced by the method herein, compared to the shorter shelf life and lower stability of liquid oat milks that lead to disposal. Also, the novel solid oat milk product and process described herein for preparing the product yield great improvements in environmental sustainability and lower costs in commercial distribution arising from lower weights and volumes to be transported, as the oat milk product is distributed in its solid form instead of liquid form as in typical commercial oat milks.

In examples, there are provided a solid compressed oat milk product comprising: 60% to 80% of a whole oat flour; 0% to 5% of an emulsifier; around 0.1% to 5% of a stabilizer; 0% to about 1% of an optional foaming enhancer; and, 15% to about 30% of an oil, wherein the final product is extruded and/or compressed. The product is packaged and stored. For use, the product is reconstituted in water.

In other examples, there are provided a solid compressed oat milk product, wherein the hydrolyzed whole oat flour, emulsifier, stabilizer and a foaming enhancer are blended by mixing in a vat, an oil is added and further blended, and wherein an appropriate amount of the final material is placed into a suitable mold and compressed @ 110-160 psi for at least 6-10 seconds. In still other examples, the solid compressed oat milk product further comprises one or more of additionally added vitamins, minerals, sweeteners, anti-caking ingredients, binders, colorants, flavors, and spices. In yet other examples, the solid compressed oat milk product of the current invention comprises about 73% of a hydrolyzed whole oat flour; about 3% of an emulsifier; about 3% to about 5% of a stabilizer; about 0.5% of a foaming enhancer; and, about 20% of an oil, where the emulsifier is selected from sunflower or soy lecithin, the stabilizers is flaxseed flour, the frothing or foaming enhancer is sodium bicarbonate (baking soda), and where the oil is sunflower oil.

In an example, a solid chocolate-flavored oat milk product of the current invention comprises hydrolyzed whole oat flour, sweetener (cane sugar), cacao powder, soy lecithin, fava bean concentrate, flaxseed flour (or similar functional stabilizer), and sunflower oil. The sweetener is, in examples, maple sugar.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific examples disclosed may be readily utilized as a basis for modifying or designing other examples for carrying out the same purposes of the present disclosure. It should also be realized by those skilled in the art that such equivalent examples do not depart from the spirit and scope of the disclosure as set forth in the appended claims.

### DETAILED DESCRIPTION OF THE INVENTION

Compressed and/or extruded formed food products of the current invention include any final product that can be shaped (e.g. round, square, etc.) solid, dry, dense, and dissolvable. The products disclosed herein are contemplated to have a wide array of applications (from milk alternatives and beverages, to jams, sauces and the like). Any product that contains dry ingredients to start and that can be fully mixed before compression, can and will benefit from this technology. The inventor contemplates that the improvements disclosed herein are applicable to a variety of products including but not limited to: compressed food products including alternative, plant-based oat milk, alternative plant-based milk blends including barista editions and flavors, and also fruit jams, fruit preserves, effervescent cocktail mixes, effervescent sodas and similar beverages, tea, tea blends, sauces or any product in which the base ingredients can be milled, dehydrated, and/or dried to be prepared as the base ingredient.

### Disclosed Products and Methods

The products and methods of the current invention avoid the problems associated with currently available methods known in the art, namely, diminished nutritive qualities and products that can be difficult to use in a commercial setting. For example, in an exemplary process, the base ingredients are milled only to a level that does not disrupt or interfere with cellular integrity of the oat base. Soaking with water is not used nor are enzymes required to break down starches and strip away unwanted molecules. However, enzymes may be added to aid in reconstitution. Ingredients are instead blended without high shear, namely, in the absence of high speed mixing that creates a high shear effect or condition, in order to maintain the structural integrity of all ingredients. The blended mixture is then parsed, molded and compressed under high pressure into various shapes, for example into balls etc. The compressed molded balls are then packaged for future use, i.e., reconstitution. When reconstituted for use, the added enzymes present are activated by the water which begins a low-level chemical digestion of the starches but does not remove or strip anything from the ingredients natural state. When consumed, the consumer is consuming the whole of the ingredients with no binders or stabilizers.

### Base Ingredients

In any example, the base ingredient can be any grain known in the art. More particularly, the base ingredient is derived from oats. Oats represent a consumer approved, healthier alternative to milk and currently available products, environmentally sustainable (less water usage, less land required to grow, no-pesticides).

### Oats

Oats are a uniquely nutritious food as they contain an excellent lipid profile and high amounts of soluble fiber. However, an oat kernel is largely non-digestible and thus must be utilized in milled form to reap its nutritional benefits. Milling is made up of numerous steps, the most important being dehulling to expose the digestible groat, heat processing to inactivate enzymes that cause rancidity, and cutting, rolling or grinding to convert the groat into a product that can be used directly in oatmeal or can be used as a food ingredient in products such as bread, ready-to-cat breakfast cereals and snack bars. Oats can also be processed into oat bran and fiber to obtain high-fiber-containing fractions that can be used in a variety of food products.

Food-processing operations are essential to converting agricultural commodities into foods that can be eaten by, and are palatable and appealing to, consumers. Through various physical and chemical operations, food processing can increase shelf-life, improve bioaccessibility of nutrients, stabilize the color and flavor, increase economic value and facilitate the preparation of raw food ingredients. See for example: Fellows, “Processed Foods for Improved Livelihoods,” (2004) Rome: Agricultural Support Systems Division, Food and Agriculture Organization of the United Nations (FAO Diversification Booklet 5) as cited in Decker et al., “Processing of oats and the impact of processing operations on nutrition and health benefits,” (2014) British J. Nutrition, 112(S2): pp. S58-S64.

Cereal grains are evolutionarily designed to be chemically, physically and biologically inactive until the proper conditions allow the seed to germinate into a new plant. This makes cereal grains a great biological tissue for the long-term storage of important micro-and macronutrients for both livestock and human beings. However, unprocessed cereal grains are not readily digestible, and must be processed to convert them into a palatable and nutritious food. See Serna-Saldivar, “Cereal grains: properties, processing, and nutritional attributes,” (2026) CRC press. Cereal grains have this property because the outer portion of the seed (the hull) is designed to protect the seed from harsh environments and if the seed is consumed unprocessed, it can pass through the entire digestive system with little or no digestion—a reproduction strategy of the plant to increase seed dispersal. Thus, milling and other processing steps are essential in converting the seed to food. The development of cereal processing has been extremely important in making cereal grains one of the most important foodstuffs.

Oats have several unique properties that make their milling different from other cereal grains: i) their hull is not connected to the endosperm; ii) they have a higher fat content than most cereal grains; and, iii) they contain high levels of soluble dietary fibers. See Girardet et al., “Oat milling: specifications, storage, and processing,” (2011) in Oats: Chemistry and Technology, 2nd ed., (Webster et al., eds.), St Paul, MN: American Association of Cereal Chemists; pp. 301-316. Further, oats have a hull that consists mainly of cellulose, hemicelluloses and lignin and within the hull is the groat, which comprises 68-72% of the kernel. See Webster, “Oats,” (1996) in Cereal Grain Quality, (Henry et al., eds.), London: Chapman and Hall. pp. 179-203.

The oat is most commonly processed as a whole grain because its groat is softer than other grains such as wheat, and thus cannot be easily converted into separate germ, endosperm and bran fractions. The outer layer of the groat is an important source of protein, neutral lipids, β-glucan, phenolics and niacin, and is sometimes separated from the groat to produce oat bran. The inner endosperm consists of proteins, starch and β-glucan while the germ contains mainly lipids and proteins. These oat components and its unique physiological structure require that oats are processed differently from other grains, and also provide them with some unique nutritional qualities that make them an important, albeit underutilized and valued, food product and sometimes an ingredient in other food products.

The inventor contemplates that the oats used in the various examples can be obtained from oat processing techniques common in the field and known to those of skill in the art. The following methods and techniques of oat processing are presented as non-limiting examples of how oats can be processed to be used in the present invention.

### Oat Milling

The quality of milled oats depends on plant genetics (varieties), agricultural practices, chemical composition, and storage and handling conditions. The genetics of the oat affects milling efficiency as kernel size and groat percentage affect yield. In addition, these factors will also be influenced by the growing environment and variations in climate, such as rainfall or frost. Chemical composition will affect both nutritional content and quality. For example, non-esterified (“free” or unsaturated) fatty acids (NEFAs) are the major component of triglycerides (the fat stores in the body), which consist of three fatty acids linked to a glycerol backbone. In healthy animals (when they are eating or not in energy-deficient states), normal NEFAs mainly come from breakdown of triglycerides ingested in the diet through chylomicrons (lipoprotein lipase liberates NEFA off chylomicron remnants). However, under fasting conditions or states of negative energy balance, the main source of NEFA is hydrolysis of fat stores in the body and NEFAs are used primarily as a marker of negative energy balance. Typically, high levels of NEFA are generally an indication of improper storage and handling that result in kernel damage, so that lipases can hydrolyze the triglyceride. The presence of NEFA decreases quality because they directly produce off-flavors and are more susceptible to developing oxidative rancidity. See McClements et al., “Lipids,” in Fennema's Food Chemistry, (Damodarin et al., eds.) (2008) Boca Raton, FL: CRC Press, pp. 155-216.

Proper storage and handling of oats is important to decrease nutrient loss and to minimize the formation of off-flavors resulting from lipid oxidation. When oats are stored in bulk, the moisture content of each individual kernel will adjust to reach equilibrium with its surrounding environment. Hence, storage conditions are an important food-preservation factor, as improper moisture control can result in the growth of microorganisms that can cause spoilage and impose food safety risks (such as the formation of aflatoxins from mold growth). See Bhatnagar et al., “Aflatoxins and Aspergillus flavus,” in Guide to Foodborne Pathogens (Labbé et al., eds.) (2013) Hoboken, NJ: John Wiley & Sons, Chapter 16. Excess temperatures can also decrease quality by increasing enzyme reactions, nutrient degradation and microbial growth, so it has been recommended that oats are stored at <0.65 water activity (approximately 13% moisture in the kernels) between 5 and 20° C. See Girardet et al., 2011. Overall, milling is designed to remove foreign materials, isolate and stabilize the groat and convert the groat into a form that is easy to cook. This involves cleaning, dehulling and kilning, and then cutting, flaking or producing flour. See Id.

The major steps of oat milling include the following.

### Cleaning

Harvesting oats will lead to co-mingling of the oats with other components found in the field and transportation process, and these foreign materials need to be removed to make oats suitable for human consumption. This is accomplished primarily by screening. When the oats enter the mill, they pass under a magnetic separator to remove foreign metal objects, a very common practice in many food-processing operations. The oats then experience a series of rotating or oscillating screens that can both retain large objects (such as straw, sticks and stone) and let small objects such as underdeveloped oats, dirt, weed seeds and dust to pass through. The retained oat stream is then subjected to aspiration to remove more of the light materials. This is followed by a dry stoner that removes high-density but similar-sized particles such as rocks and other grains, such as maize. In some cases, oats undergo clipping before cleaning, cutting off the tip of the oats to make later dehulling more efficient. Clipping is done before cleaning so the clipped off portion can be removed before further milling. Clipping utilizes a meshed screen into which the narrow end of the oat can penetrate. A rotating bar then displaces the oat from the mesh resulting in the tip being broken off, and the cut-off tips are removed by aspiration.

A rotary separator can also be used to sort the oats into different size classes, which can increase milling efficiency by eliminating small kernels that do not have a large percentage of groat. An indented rotary drum is used for this process. An indent separator is designed as its name implies, with indents on the inner face of a rotating cylinder that are the size of the seeds that are to be removed-an indent separator that is designed to remove the seeds of weeds has indents smaller than the oats, for example. The weed seeds fit tightly into the indents and are carried high up the side of the rotating cylinder, and the tight fit of the seed in the indent allows it to be carried far up the side of the cylinder until the pull of gravity drops the weed seed into a trough that is in the center of the cylinder. The seeds in the trough are then removed by a screw conveyor and the larger oats, which are not lifted high enough up the side walls, continue to move out of the bottom of the cylinder. The size of the particle removed by the screw conveyor can be adjusted by adjusting the height of the catch trough. The lower the trough, the larger the particles that are separated, because even particles that do not tightly fit in the indents will rise up the sides of the cylinder due to friction. Some small oats such as light oats, double oats and pin oats can be removed by this process and are used as animal feed. See for example Id.

### Grading

To operate the oat mill at maximum efficiency, the isolated oats must be divided into different sizes, which is done using the differences in the density and weight of the oat fractions. Id. Most graders separate oats based on width, as this is the most accurate way to isolate oats with similar weights. Width separation uses a series of perforated cylinders. The first has an intermediate perforation that allows the small-and medium-width oats to pass through the cylinder, with the larger oats being carried out of the end of the cylinder (over-tail). The small and medium oats then enter a second perforated cylinder with smaller holes, which allow the smallest oats to pass through.

### Dehulling

The hull is highly indigestible, so it must be removed to obtain maximum nutritional benefits. This can be accomplished through any of the several dehulling procedures known in the art.

### Kiln Drying

Oats are somewhat unusual in that they contain 6-8% fat compared to 2-3% fat in most other grains. Oats also contain high PUFA (35% linoleic acid; and high levels of lipid-digesting enzymes. See Stewart et al., “Oat agriculture, cultivation and breeding targets: Implications for human nutrition and health,” (2014) Br J Nutrition, 112 (S2): pp. S50-S57. The main forms of lipids in oats are phospholipids and triacylglycerols that are susceptible to hydrolysis by lipase into NEFA. Oats tend to have higher lipase activity than other grains such as rice or wheat. The NEFA produced by lipase not only has an unappealing soapy taste but can also react with lipoxygenases, which catalyze the conversion of unsaturated fatty acids (most commonly linoleic acid) into fatty acid hydroperoxides. These hydroperoxides can decompose into a series of volatile fatty acid decomposition products, such as hexanal, which produce rancid aromas. See McClements et al. 2008. In the intact grain kernel, lipase and lipoxygenase are physically compartmentalized, so they do not react with triacylglycerols and phospholipids. However, during milling, most compartmentalization is destroyed, allowing the enzymes and lipids to interact. Therefore, to control off-flavor development before this decompartmentalization, lipase and lipoxygenase must be inactivated by heat denaturation. This is accomplished by first applying live steam (steaming) and then applying heat for an extended period, known as kilning. An additional advantage of kilning is that it increases the Maillard reaction, which is a reaction between proteins and carbohydrates that produces desirable flavors, browning and the formation of antioxidant compounds that further increase the stability of lipids. See Id.

Kilning is most commonly conducted by placing the groats in long vertical cylinders and then injecting steam and air into the columns. See Girardet et al., 2011. The live steam is injected into the top of the column to increase the temperature of the groat rapidly. The steam increases the moisture content of the groats, which is advantageous because the efficiency of enzyme inactivation increases with increasing moisture content. However, increased moisture content of the groats can reduce the quality and storage stability of the final products, so further down the column the groats are subjected to radiant heating (dry heat) to evaporate excess moisture. An added advantage of radiant heating is that this accelerates the Maillard reaction, producing desirable nutty flavors and caramel colors. Towards the end of this process, air is injected into the groats to decrease temperature and remove moisture to a final water content of 10%. The effectiveness of enzyme inactivation is monitored by measuring peroxidase activity. Peroxidase is more heat stable than lipase and lipoxygenase, so its complete inactivation ensures that lipase and lipoxygenase are also inactivated.

Kilning is also advantageous to oat quality in that it can inactivate bacteria, yeasts and molds that can decrease shelf-life and pose food safety risks. However, as with all thermal-processing treatments, kilning will also destroy some heat-liable vitamins such as B vitamins-but the benefits of the ability of kilning to extend shelf-life far outweigh these undesirable effects.

### Converting Groats

After milling, the final products include whole groats of varying sizes, broken groats and powdered fines. These different products can be used to make oat flakes, steel-cut oats, oat flour and oat bran, and in some cases can be used to produce oat ingredients such as fiber. Steel-cut oats are produced by simply cutting the whole groats into smaller pieces. Oat flakes are produced simply by flattening either whole or steel-cut groats with rotating rollers. However, the groats exiting kiln drying are very susceptible to crushing into powder because of their low moisture content. To avoid this, before rolling, the groats are exposed to steam during agitation before rolling, with the goal of adding 3-5% moisture. This process can take 20-30 min and will increase the temperature of the groats. In an optimal process, moisture equilibration should be achieved with the smallest possible temperature increase over the shortest time to minimize nutrient degradation. See Girardet et al., 2011. The skilled artisan would understand that oat flake thickness can be controlled by varying the rolling parameters to achieve different results, i.e. the thinner the flake the faster they cook. In general, quick-cooking flakes are rolled thinner (0. 36-0.46 mm) than whole-oat flakes (0.51-0.76 mm). Even thicker flakes are produced for products such as muesli. The thickness of the flakes can vary from 0.7-1.2 to <0.4 mm for quick-cooking oats. After rolling, the flakes are passed through an air stream to decrease both their temperature and moisture content, returning the flakes to 10-12% water. Finally, steps include processes such as shaking to break apart clumps of flakes and remove fines and small flakes. The combination of steam followed by drying can cause the starch in the oat flakes to become partially pregelatinized. Pregelatinized starch will more rapidly absorb watered than unprocessed starch, thus decreasing the cooking time.

### Flour

Groats or oat flakes can be ground with a pin or hammer mill into flour. During grinding, the oat flour tends to clump due to its high fat content, so air is used to move the flour through the mill and decrease heat build-up. After exiting the mill, the flour goes through a vibrating shifter-this removes the remaining large particles, which are recycled into a second milling. Oat flour is primarily used for baby food and ready-to-cat cereals.

### Oat Bran

Oat flour can be separated into coarse and fine fractions. The coarse fraction is referred to as bran that comes from the outer aleurone and subaleurone layers of the groat and is higher in fibre, protein, vitamins and minerals, and is slightly higher in fat. The fine fraction has a high starch content. The coarser bran fraction is separated by shifting the oat flour. Typically, oat bran has a total dietary fiber content of at least 16%, with one-third of the fiber being soluble and a β-glucan content of at least 55%.

### Oat Hulls

Oat hulls constitute 28-32% of the oat and thus represent a challenge for by-product utilization. The hulls contain 30-35% fibre, 30-35% pentosans, 10-15% lignans, protein and ash—the latter is high in silicic acid. See Id. If the hulls are finely ground, they can have application as high-fibre animal feed and human food ingredient applications. Oat hulls also can be used as biomass for power plants to produce electricity.

### Concentrated β-Glucan

Several techniques can be used to process oat grain into fractions that are higher in β-glucan. This is accomplished by dry milling techniques to remove the starch from oat bran which can be done by drying the oat bran and then conducting an additional grinding or rolling step to help release the starch from the β-glucan. The fiber and starch fractions are then separated by sieving and aspiration.-Glucan concentrations can be increased to 12-22 % by using these processes. β-Glucan concentrations can also be increased by solubilizing the β-glucan with water, heat and shearing to decrease viscosity. This slurry can then be passed through a sieve or centrifuged to separate non-solubilized components such as starch. Alternatively, β-glucan can be concentrated by utilizing enzymes that degrade starch, protein and lipid. This can be done by simply adding water to the oats and allowing the endogenous enzymes to digest the non-fibre components. Exogenous a-amylase and trypsin can also be added to aid in the hydrolysis of starch. These techniques can increase β-glucan concentrations used in high-fiber foods, and, because they can be used to increase viscosity, they can also be used to replace fats in certain foods. However, these are multiple-step processes, meaning that enrichment leads to a net increase in price per kg compared to the original oat. See for example Decker et al. 2014.

### Ingredients

The following provides a summary of various ingredients useful for the different examples of the current invention.

### Non-Hydrolyzed Oat flour Without Enzyme Modification

The inventor has found that the various examples of the current invention, directly to compressed oat milk and compressed oat milk products, can utilize any oat flour known to those of skill in that art. In examples herein, the oat flour is hydrolyzed oat flour or non-hydrolyzed oat flour. In an example, the oat flour is non-hydrolyzed, and the oat milk product is prepared with the addition of an enzyme that is activated to perform a hydrolysis reaction with the oat flour. The activation reaction occurs after the prepared oat milk product is prepared for use, by dissolving the oat milk product in water. In an example, the enzyme selected for this addition is amylase. The enzyme activation occurs after exposure of the enzyme to water.

### Hydrolyzed Oat Flour

The inventor has found that in particular examples, use of hydrolyzed oat flour is advantageous. Hydrolyzed oat flour can be produced by methods common in the field. Continuous process using oat (Avena sativa L.) that have been milled and then hydrated in a tank at a determined solids content. Amylase and cellulase enzymes are added at 135-150° F. for a x time to break down starches into sucrose and glucose to a dextrose equivalent of 35. The liquid oat blend is then flash heated to 285° F. to denature/deactivate enzymes and chilled to 40° F. Product is then dried through a spray drier, resulting in a particle size of less than 20 microns. Other methods for drying exist, including drum drying and extrusion, resulting in different finished product properties. See for example He et al., “Fabrication and characterization of oat flour processed by different methods,” (2020) J. Cereal Sci 96:103123.

Since the plant-based beverage dairy category does not have specified criteria detailing standards of said product(s), the inventor conducted several industry focused, expert led, evaluations which compared and contrasted leading plant-based oat milks against conventional oat flour formulae and the currently disclosed hydrolyzed oat flour formula. It was found that the hydrolyzed oat flour formula yields key improvements in terms of taste, mouth feel, consistency, and overall functionality including foaming, heat tolerance, and shelf life, but also most, if not all, of the leading oat milk beverages currently available in the marketplace. Results of scoring conducted by leading barista foam competition judges rated the product produced by the process herein at 4.5 on a 5 point scale for use in a latte application as compared to competition rated 3.0.

In addition, several oat flours were reviewed during the discovery, including colloidal oat flour, pregelatinized oat flour, hydrolyzed oat flour, fine and extra fine grind sizes were all evaluated. Particle size was related to finished viscosity, mouthfeel, and stability over-shelf life. Particle size less than 20 μm made an ideal product.

### Other Ingredients

Other ingredients include various stabilizers and emulsifiers including but not limited to milled flaxseed flour, sunflower lecithin, soy lecithin and blends thereof. Enhancing the formula with protein also proved helpful in creating and maintaining foam in a barista/latte application where milk is subjected to high pressure steam to heat and foam. Several types of proteins suitable for the formulation include plant-based options, for example, pea protein, rice protein, chia seed flour, and proteins of fava bean, navy-bean, or other pulses. Fava bean protein concentrate (also referred to herein as fava bean concentrate) is a concentrate produced by a clean mechanical separation process from fava beans. The fava bean concentrate is a vegetal protein that has high solubility and good emulsifying properties.

Suitable salts for inclusion in the formulation include, but are not limited to, sodium citrate and sodium chloride. In an example, sea salt is used.

Suitable sweeteners are included in examples according to the invention to enhance sweetness and flavor. In exemplary formulas, suitable sweeteners include nutritive and non-nutritive sweeteners such as sugar (such as sugar in white, granulated, confectioners, beet, or cane forms), maple sugar, brown sugar, dehydrated honey, acesulfame potassium, advantame, aspartame, neotame, saccharin, sucralose, luo han guo (Monk fruit), sugar alcohols such as sorbitol and xylitol, stevia leaf extracts or any combination thereof. To maintain the preferred low moisture content in the dry base mixture, in an example of the invention, high-moisture or liquid sweeteners are to be excluded from the ingredients of the product.

Suitable stabilizers include flaxseed flour. Products of the current invention in certain examples can include an enzyme. In examples, the enzyme is amylase. This enzyme breaks down large, complex, insoluble starch molecules to smaller, soluble, and digestible sugar molecules. This is important nutritionally, because it begins the digestive process, and provides a digestible form of starch, which leads to energy production. This “enzyming” process reduces slime, and creates a smooth, creamy mouth feel. It also creates a natural sweetness by breaking down the starches into sugar.

Products of the current invention can include an emulsifier. In an example, the emulsifier is sunflower lecithin or soy lecithin. Lecithin can be added for emulsification purposes, as well as lubrication, flavor protection, and nutritional purposes.

Products of the current invention can include an oil. In an example, the oil is sunflower oil. Neutral oils in general (vegetable oil, peanut oil, rapeseed oil, canola oil, corn oil, soybean oil, avocado oil, grapeseed oil, and/or safflower oil) and sunflower oil in particular are utilized to produce creamy, smooth, mouth feel, satiety, and to increase the uptake of fat-soluble vitamins. Sustainably sourced and good for the environment, sunflowers may provide a good alternative to more water-intensive crops, while also creating habitats and food for beneficial pollinators and insects.

Products of the current invention can include an ingredient to improve frothing or foaming, particularly when high heat and or pressure are applied to the resulting reconstituted oat milk product. As used herein, “frothing or foaming enhancer” and “foaming enhancer” are used interchangeably to describe a component that produces a frothing or foaming effect. In examples, the frothing or foaming enhancer includes baking soda. The frothing or foaming enhancer may, in examples, be calcium carbonate.

It is noted that some baking powder formulations (as contrasted with baking soda) may contain phosphates. The inventor has determined that the oat milk product and the process of the instant invention have key beneficial effects derived from the absence of phosphates in the oat milk product, or from excluding phosphates, or from avoiding the addition of phosphates during production of the oat milk product. Human health concerns surround excess phosphorus or phosphate content in processed foods and beverages. The concerns have led to consumer demand for limiting levels of phosphorus or phosphate additive in foods and beverages. A key benefit of the process and product described herein is providing an oat milk product having no added phosphorus or phosphates, or having lowered phosphate levels as compared to other oat milk products. The process and product described herein provide these key benefits, and surprisingly do so without compromise to shelf life or quality of the resulting oat milk product.

The inventor contemplates that any of the formulae disclosed herein can contain additional and/or alternative ingredients including: vitamins, minerals, anti-caking ingredients, binders such as potassium bicarbonate, colorants, flavors, spices, and the like.

### Process for Making a Compressed Oat Milk Product

The disclosed process is different from those known in the art to make traditionally made oat milks because the inventor has discovered the importance of keeping the base and other ingredients past their original powder state without soaking or straining which can unnecessarily remove nutrients thus making “healthier” beverage alternative to milk.

An exemplary process disclosed herein is an extrusion, as, for example, is used to produce the product without employing the process of granulation.

Another differentiator is an “enzyming” step. For example, the inventor has discovered the use of amylase in the formula to produce and promote a non-slimy, creamy, rich, and silky mouthfeel. The amylase breaks down the starches and keeps them broken down, resulting in the desired mouth experience and sweetening the product slightly, naturally. The disclosed method is proprietary, which is stated above, which results in a vastly superior product and noticeably different physical properties, while also maintaining high nutritional value.

### Extrusion Process

The skilled artisan will recognize that extruders, such as used for cold dough are known in the art. Here, the mixing and extrusion steps are used to extrude the mixed oat ingredients which typically have the consistency of dough. The typical cold dough extruder includes an inlet hopper and a feeding or dough driving mechanism. The hopper holds the dough load coming from the mixer and becomes a balance tank. Hoppers have a special conical configuration, using gravity to convey the dough downwards. Typically, two or three rollers force the dough into a “pressure chamber” that is located just before the die. The rollers run continuously (at low rotation speed that can be locally adjusted) or intermittently to force dough out of the pressure chamber at the die. In other systems, a single- or twin-screw feeder is used for handling different product rheology and consistency. A die, nozzle or orifice, functions as the final forming mechanism. Different diameters, shapes, configurations (e.g. concentric) and construction materials can be used, depending on the rheology and stickiness of the dough, product filling needs and desired form of the finished product. Dough can be cut by any of several mechanisms including wire-cutting such that once the dough is extruded, and a wire or blade mounted on a frame moves through the dough just below the die outlet. The cut dough pieces are then dropped onto a conveyor band for transport to the oven. The number of strokes ultimately determines the output (units per min) of this type of extrusion configuration. Another cutting configuration is known as “bar-or rout-press.” Unlike the wire-cut system, a continuous ribbon of dough is extruded through the die, usually concentric.

The product herein was developed using two types of compression, both of which are viable. Single compression by way of direct tablet compression, compression from machinery that include, but is not limited to, a bath bomb compressor, and other mechanical forms of compression machinery that uses medium to high pressure (PSI) to mold and form a variety of shapes and sizes, resulting in a final product that processes all characteristics of product type being introduced into the marketplace. The second form of compression is in the form of mechanical extrusion, which applies pressure while moving product through a die, which forms and shapes the final product before it is packaged.

### Finished Oat Milk

In certain examples, the Final Product is a compressed oat milk product. The final extruded, wrapped and stored oat blend is added to an appropriate amount of water in a blender. The blended oat milk can then be refrigerated, used in any further product (e.g. coffee) or stored.

Further reference is made to the following experimental examples.

### EXAMPLES

The following examples are provided for the purpose of illustrating various examples of the invention and are not meant to limit the present disclosure in any fashion. The present examples, along with the methods described, are representative examples, and are not intended as limitations on the scope of the invention. Changes therein and other uses which are encompassed within the spirit of the disclosure as defined by the scope of the claims will occur to those skilled in the art.

### Example 1

### Compressed Oat Milk Product

The inventor has found an exemplary formula for a solid oat milk product as shown in

TABLE 1:

TABLE 1

| | % Formula | % Formula Range |
|---|---|---|
| Ingredient | (by weight, wt %) | (by weight, wt %) |
| Hydrolyzed Whole Oat | 73.07% | 60-80% |
| Flour | | |
| Sunflower Lecithin | 3.04% | 0-5% |
| Flaxseed flour (or similar | 3.04% | 0.1-5% |
| functional stabilizer) | | |
| Sodium bicarbonate | 0.54% | 0-1% |
| Sunflower Oil | 20.30% | 15-30% |
| TOTAL | 100.00% | 100% |

In an exemplary process, the components of the formula as set forth in Table 1 each are measured by weight as a weight percent (wt %) of the total weight of the resulting composition. The whole oat flour, sunflower lecithin, flaxseed flour, and sodium bicarbonate are mixed or blended together, each in their dry form to form a dry base. This step of mixing or blending is conducted dry, without addition of waters or oils. High shear mixing is to be excluded. Low shear blending or mixing is desirable in order to maintain the structural integrity of all ingredients.

After the initial dry blending to form the dry base, the sunflower oil is added to the dry base. The sunflower oil is blended into the dry base. High shear mixing is to be excluded. Low shear blending or mixing is desirable in order to maintain the structural integrity of all ingredients. After this blending, the oil/base blend forms a dough.

The dough is compressed or extruded. In an exemplary process, the dough is compressed, in a compression conducted in a mold. The mold may form the dough in a ball shape or other suitable shape for commercial packaging. The ball of dough is compressed at, for example, 110 pounds per square inch (psi). In an example, the dough is extruded into a desired shape. In an example, the compression is conducted at a pressure of 110 psi for at time of at least 6 seconds.

After compression and/or extrusion, the resulting compressed or extruded product is ready for packaging for its shelf life. In an exemplary process, the product may be transferred to drying rack prior to packaging, but the inventor considers that the low moisture content achieved in the product as prepared by the process as a key benefit of the process and the resulting product, namely avoidance of the need for dehydration steps. Dehydration steps use energy, and thus increase processing cost and create negative environmental impact. In an example, the product prepared by the process contains a low moisture or water content, sufficiently low to remain shelf stable for at least one year, as packaged, subsequent to production according to the process described.

The product thus is prepared as a solid compressed and/or extruded oat milk product. In an example, the product is wrapped, packaged, and stored.

The resulting stored solid oat milk product prepared according to the process has a shelf life of about one (1) year. Testing has determined that the water activity level of the oat milk product prepared according to the process is low, at 0.288. Water activity below a level of 0.6 will not allow for microbial or yeast and mold growth, and thus provides for an extended shelf life and higher product stability over time, assuming that packaging is sufficient for protection from light and moisture uptake. Minimum water activity levels are known for most gram-negative bacteria (minimum water activity level 0.97); most gram-positive bacteria (minimum water activity level 0.90); most yeasts (minimum water activity level 0.88); most filamentous fungi (minimum water activity level 0.80); halophilic bacteria (minimum water activity level 0.75); xerophilic fungi (minimum water activity level 0.61); and osmophilic yeasts (minimum water activity level 0.60). The solid product according to examples herein thus has longer shelf life and higher stability over time compared to liquid oat milk products.

In examples of use, the solid oat milk product is reconstituted in water. In examples, the disclosed product is a solid oat milk product or a solid oat cream product. The solid oat milk product or oat cream product is, in examples, added to water to be reconstituted as a liquid oat milk product or a liquid oat cream product. In examples, the solid oat milk or solid oat cream product, reconstituted in water, is added to coffee or tea beverages as alternatives to dairy-based beverage additives such as milk or cream, or as alternatives to non-dairy coffee creamers or whiteners. In examples, the solid oat milk product or solid oat cream product is added in its solid form to coffee or tea beverages, without prior reconstitution in water, to function as alternatives to beverage additives such as milk, cream, coffee creamers, or coffee whiteners.

In an example, the solid oat milk product is formed using the process of Example 1, compressed into a ball having a weight of 89.61 grams (about 90 grams). For use, the ball is added to 30 fluid ounces of water, and to be reconstituted and mixed to dissolve in the water to form about 32 fluid ounces of oat milk that is ready for use.

The product functions similar or better than currently available oat milk beverage products regarding foaming, flavor, mouthfeel/consistency, and stability. High foam generation is a favorable feature of oat milks that are used in barista or home beverage preparation. Foaming tests were conducted comparing foam generation yielded by samples of available commercial oat milk products to foam generation yielded by samples of oat milk prepared according to examples of the invention set forth in this disclosure.

The test method included heating 500 mL samples of liquid oat milk to 120° F. in graduated cylinders (microwave heating at two minutes). The heated oat milk samples were frothed using a handheld frothing tool. The total volume of foam generated by each sample was measured. The test results are set forth in TABLE A:

TABLE A

| Oat Milk | Temperature | Frothing time | Amount of foam |
|---|---|---|---|
| Sample | (° F.) | (min) | generated (mL) |
| EXEMPLARY | 120.5 | 2 | 150 |
| SAMPLE 1 | | | |
| EXEMPLARY | 120.3 | 2 | 200 |
| SAMPLE 2 | | | |
| Commercial Brand A | 120.7 | 2 | 50 |
| Commercial Brand B | 120.9 | 2 | 125 |
| Commercial Brand C | 120.2 | 2 | 100 |

Exemplary Sample 1 was an oat milk prepared by reconstituting, in 30 fluid ounces of water, a solid oat milk product ball prepared in accord with the disclosed ingredients and processes according to the invention. The dry base ingredients used to prepare the Exemplary Sample 1 ball are whole oat flour, fava bean protein, flaxseed flour, sunflower lecithin, and sea salt. After mixing the dry base ingredients, the resulting dry base was mixed with sunflower oil. The resulting dough was compressed into the solid oat milk product in a ball form having a weight of about 90 grams. Exemplary Sample 2 was an oat milk prepared by reconstituting, in 30 fluid ounces of water, a solid oat milk product ball prepared in accord with the disclosed ingredients and processes according to the invention. The dry base ingredients used to prepare the Exemplary Sample 2 are the same as those listed above with respect to Exemplary Sample 1, with the addition of baking soda. After mixing the dry base ingredients, the resulting dry base was mixed with sunflower oil. The resulting dough was compressed into the solid oat milk product in ball form, the ball having a weight of about 90 grams. Commercial Brands A, B, and C were liquid oat milk samples as sold in their typical commercial packaging. TABLE A shows the higher volumes of foam generation yielded by Exemplary Samples 1 and 2, compared to the volumes of foam generation yielded by Commercial Brands A, B, and C.

### Example 2

### Flavored (Chocolate) Oat Milk Compressed Product

The inventor has found a preferred formula for a solid chocolate-flavored oat milk product as shown in TABLE 2:

TABLE 2

| | % Formula | % Formula Range |
|---|---|---|
| Ingredient | (by weight, wt %) | (by weight, wt %) |
| Hydrolyzed Whole Oat | 45.5% | 40-55% |
| Flour | | |
| Sweetener (cane sugar) | 10% | 5-20% |
| Cacao powder | 11.3% | 5-30% |
| Soy Lecithin | 4.3% | 1.0-5% |
| Fava bean concentrate | 1.4% | 1-5% |
| Flaxseed flour (or similar | 1.4% | 0.5-3% |
| functional stabilizer) | | |
| Sunflower Oil | 26.1% | 20-30% |
| TOTAL | 100.00% | 100% |

In an exemplary process under Example 2, the components of the formula as set forth in Table 2 are processed in a method similar to that set forth above with respect to Example 1. Each of the ingredients are measured by weight as a weight percent (wt %) of the total weight of the resulting composition. The whole oat flour, sweetener, cacao powder, soy lecithin, fava bean concentrate, and flaxseed flour are mixed or blended together, each in their dry form to form a dry base. This step of mixing or blending is conducted dry, without addition of waters or oils. High shear mixing is to be excluded. Low shear blending or mixing is desirable in order to maintain the structural integrity of all ingredients.

After the initial dry blending to form the dry base, the sunflower oil is added to the dry base. The sunflower oil is blended into the dry base. High shear mixing is to be excluded. Low shear blending or mixing is desirable in order to maintain the structural integrity of all ingredients. After this blending, the oil/base blend forms a dough.

The dough is compressed or extruded. In an exemplary process, the dough is compressed, in a compression conducted in a mold. The mold may form the dough in a ball shape or other suitable shape for commercial packaging. The ball of dough is compressed at, for example, 110 pounds per square inch (psi). In an example, the dough is extruded into a desired shape. In an example, the compression is conducted at a pressure of 110 psi for at time of at least 6 seconds.

After compression and/or extrusion, the resulting compressed or extruded product is ready for packaging for its shelf life. In an exemplary process, the product may be transferred to drying rack prior to packaging, but the inventor considers that the low moisture content achieved in the product as prepared by the process as a key benefit of the process and the resulting product, namely avoidance of the need for dehydration steps. Dehydration steps use energy, and thus increase processing cost and create negative environmental impact. In an example, the product prepared by the process contains a low moisture or water content, sufficiently low to remain shelf stable for at least one year, as packaged, subsequent to production according to the process described.

The product thus is prepared as a solid compressed or extruded chocolate-flavored oat milk product. In an example, the product is wrapped, packaged, and stored. The resulting stored solid oat milk product has a shelf life of about one (1) year. For use, the solid oat milk product is reconstituted in water.

The solid oat milk products of the disclosed invention have benefits over currently available liquid oat milk products relating to waste reduction and environmental sustainability. The solid product may be shipped in a more compact and economical solid form, contrasted to oat milks shipped as liquid in containers. The containers of the liquid product are larger and require use of more packaging material than the solid oat milk product of the invention herein.

### Example 3

### Oat Milk Liquid Product

The inventor has found a preferred formula for an oat milk liquid product as shown in Table 3:

TABLE 3

| | % Formula | % Formula Range |
|---|---|---|
| Ingredient | (by weight, wt %) | (by weight, wt %) |
| Hydrolyzed Whole Oat | 7.5% | 5-10% |
| Flour | | |
| Sunflower Lecithin | 0.31% | 0.1-.5% |
| Fava Bean Protein | 1.04% | 0.1-3% |
| Flaxseed flour | 0.31% | 0.1-0.5% |
| Sodium bicarbonate | 0.03% | 0.01-0.1% |
| Sunflower Oil | 2.29% | 1.0-5.0% |
| Water (to volume) | 88.52% | 80-95% |
| TOTAL | 100.00% | 100% |

In an exemplary process under Example 3, the components of the formula as set forth in Table 3 are measured by weight as a weight percent (wt %) of the total weight of the resulting composition. The whole oat flour, sunflower lecithin, fava bean protein, flaxseed flour, and sodium bicarbonate are mixed or blended together, each in their dry form to form a dry base. . . . High shear mixing is to be excluded. Low shear blending or mixing is desirable in order to maintain the structural integrity of all ingredients.

Oil is added to the dry base, and the resulting mixture is further blended at a low shear. High shear mixing is to be excluded. Low shear blending or mixing is desirable in order to maintain the structural integrity of all ingredients. The water is added and blended into the mixture at low shear. A liquid oat milk product is produced.

In a first set of examples according to the invention, there are provided solid oat milk products comprising about 60% to about 80% by weight of whole oat flour; about 0% to about 5% by weight of an emulsifier; about 0.1% to about 5% by weight of a stabilizer; about 0% to about 1% by weight of a foaming enhancer; and, about 15% to about 30% by weight of an oil. In one example, the oat milk product is form by mixing together, in dry form, the oat flour, emulsifier, stabilizer, and foaming enhancer to form a dry base, blending the oil into the dry base to form a dough, and compressing the dough to form the oat milk product. In another example, the product of the first set of examples is produced by mixing all the dry base ingredients and the oil in a single mixing step.

In a second set of examples, there are provided the products of the first set, wherein the whole oat flour is a hydrolyzed whole oat flour or is a non-hydrolyzed whole oat flour. In a third set of examples, the dry base further comprises an enzyme that is mixed in dry form with the oat flour, emulsifier, stabilizer, and foaming enhancer to form the dry base. In a fourth set of examples, the enzyme is amylase. In a fifth set, the compressing step of the first set is performed by extruding the dough under pressure.

In a sixth set of examples, the products of the first set of examples comprise, as emulsifiers or stabilizers, one or more of various emulsifiers or stabilizers selected from the group of: flaxseed flour, sunflower lecithin, soy lecithin, protein concentrates, pea protein, rice protein, chia seed flour, fava bean protein, navy-bean protein, or protein of other pulses, or blends of any of the foregoing.

In a seventh set of examples, the products of the first set of examples comprise a foaming enhancer that is baking soda.

In an eighth set of examples, the products of the first set of examples further comprise one or more of added vitamins, minerals, sweeteners, anti-caking ingredients, binders, colorants, flavors, and spices. In a ninth set of examples, the products of the first set of examples comprise cacao powder and sugar in the dry base.

In a tenth set of examples, the dry base mixing step of the first set of examples is conducted without high shear. In an eleventh set of examples, the oil blending step of the first set of examples is conducted without high shear.

In a twelfth set of examples, there is provided solid oat milk products comprising about 73% by weight of whole oat flour; about 3% by weight of emulsifier; about 3% to about 5% by weight of stabilizer; about 0.5% by weight of foaming enhancer; and about 20% by weight of oil.

In an additional set of examples, there is provided solid oat milk products of the first set of examples wherein the oat milk products are substantially free of phosphates. In an additional set of examples, there is provided solid oat milk products of the first or twelfth sets of examples wherein the oat milk product contains a water content sufficiently low to remain shelf stable for at least one year.

In an additional set of examples, there is provided solid oat milk products comprising about 60% to about 80% by weight of whole oat flour; at least one emulsifier; at least one stabilizer; a salt; and, about 15% to about 30% by weight of an oil, wherein the oat milk product is formed by mixing together, in dry form, the oat flour, the at least one emulsifier, the at least one stabilizer, and the salt to form a dry base, blending the oil into the dry base to form a dough, and compressing the dough to form the oat milk product. In an example further to the preceding set of examples, the product further comprises a foaming enhancer. In an example further to the preceding set of examples, the foaming enhancer is baking soda, and the at least one emulsifier comprises fava bean concentrate and sunflower lecithin, and the at least one stabilizer is flaxseed flour.

In an additional set of examples, there is provided oat milk products comprising about 40% to about 55% by weight of whole oat flour; about 5% to about 20% by weight of a sweetener; about 5% to about 30% by weight of cacao powder; about 1.0% to about 5% by weight of soy lecithin; about 1% to about 5% by weight of fava bean concentrate; about 0.5% to about 3% by weight of flaxseed flour; and, about 20% to about 30% by weight of an oil, wherein the oat milk product is formed by mixing together, in dry form, the whole oat flour, sweetener, cacao powder, soy lecithin, fava bean concentrate, and flaxseed flour, to form a dry base, blending the oil into the dry base to form a dough, and compressing the dough to form the oat milk product.

While examples of the present disclosure have been described herein, it is to be understood by those skilled in the art that such examples are provided by way of example only. Numerous variations, changes, and substitutions will now occur to those skilled in the art without departing from the invention. It should be understood that various alternatives to the examples of the invention described herein may be employed in practicing the invention. It is intended that the following claims define the scope of the invention and that methods and structures within the scope of these claims and their equivalents be covered thereby.

It is understood that while the use of words such as preferable, preferably, preferred, more preferred, should, etc., utilized in the description above indicate that the feature so described may be more desirable, the feature nonetheless may not be necessary, and embodiments or examples lacking the same, and excluding the same, also are contemplated as within the scope of the invention. In some instances, exclusion of particular steps or features forms an inherent part of the improvements in the invention. Such exclusion is, in some examples, necessary for the provision of the benefits of improved environmental sustainability; simplicity of production, distribution, and use; and general cost-effectiveness, all of which arise from exclusion of particular features from the claimed invention. The above-described embodiments of the present invention have been provided to illustrate various aspects of the invention. However, it is to be understood that different aspects of the invention shown in different specific embodiments are to be combined to provide other embodiments of the invention.

1. A solid oat milk product comprising:
about 60% to about 80% by weight of whole oat flour;
about 0% to about 5% by weight of an emulsifier;
about 0.1% to about 5% by weight of a stabilizer;
about 0% to about 1% by weight of a foaming enhancer; and,
about 15% to about 30% by weight of an oil,
wherein the oat milk product is formed by
mixing together, in dry form, the oat flour, emulsifier, stabilizer, and foaming enhancer to form a dry base,
blending the oil into the dry base to form a dough, and compressing the dough to form the oat milk product.

2. The solid oat milk product according to claim 1, wherein the whole oat flour is a hydrolyzed whole oat flour.

3. The solid oat milk product according to claim 1, wherein the whole oat flour is a non-hydrolyzed whole oat flour.

4. The solid oat milk product according to claim 3, wherein the dry base further comprises an enzyme that is mixed in dry form with the oat flour, emulsifier, stabilizer, and foaming enhancer to form the dry base.

5. The solid oat milk product according to claim 4, wherein the enzyme is amylase.

6. The solid oat milk product according to claim 1, wherein the compressing step is performed by extruding the dough under pressure.

7. The solid oat milk product according to claim 1, wherein the emulsifier is sunflower lecithin.

8. The solid oat milk product according to claim 1, wherein the emulsifier is soy lecithin.

9. The solid oat milk product according to claim 1, wherein the stabilizer is flaxseed flour.

10. The solid oat milk product according to claim 1, wherein the foaming enhancer is baking soda.

11. The solid oat milk product according to claim 1, further comprising one or more of added vitamins, minerals, sweeteners, anti-caking ingredients, binders, colorants, flavors, and spices.

12. The solid oat milk product according to claim 1, further comprising cacao powder and sugar in the dry base.

13. The solid oat milk product according to claim 1, wherein the mixing step is conducted without high shear.

14. The solid oat milk product according to claim 1, wherein the blending step is conducted without high shear.

15. The solid oat milk product according to claim 1, wherein the dough is compressed in a mold at a pressure of about110 psi for at least 6 seconds.

16. The solid oat milk product according to claim 1, wherein the oat milk product comprises
about 73% by weight of the whole oat flour;
about 3% by weight of the emulsifier;
about 3% to about 5% by weight of the stabilizer;
about 0.5% by weight of the foaming enhancer; and
about 20% by weight of the oil.

17. The solid oat milk product according to claim 1, wherein the oat milk product is substantially free of phosphates.

18. The solid oat milk product according to claim 1, wherein the oat milk product contains a water content sufficiently low to remain shelf stable for at least one year.

19. A solid oat milk product comprising:
about 60% to about 80% by weight of whole oat flour;
at least one emulsifier;
at least one stabilizer;
a salt; and,
about 15% to about 30% by weight of an oil,
wherein the oat milk product is formed by
mixing together, in dry form, the oat flour, the at least one emulsifier, the at least one stabilizer, and the salt to form a dry base,
blending the oil into the dry base to form a dough, and
compressing the dough to form the oat milk product.

20. The solid oat milk product according to claim 19, further comprising a foaming enhancer.

21. The solid oat milk product according to claim 19, further comprising a foaming enhancer, wherein the foaming enhancer is baking soda, and wherein the at least one emulsifier comprises fava bean concentrate and sunflower lecithin, and the at least one stabilizer is flaxseed flour.

22. A solid oat milk product comprising:
about 40% to about 55% by weight of whole oat flour;
about 5% to about 20% by weight of a sweetener;
about 5% to about 30% by weight of cacao powder;
about 1.0% to about 5% by weight of soy lecithin;
about 1% to about 5% by weight of fava bean concentrate;
about 0.5% to about 3% by weight of flaxseed flour; and
about 20% to about 30% by weight of an oil,
wherein the oat milk product is formed by
mixing together, in dry form, the whole oat flour, sweetener, cacao powder, soy lecithin, fava bean concentrate, and flaxseed flour, to form a dry base,
blending the oil into the dry base to form a dough, and compressing the dough to form the oat milk product.
